(19) United States
(12) Patent Application Publication
(10) Pub. No.: US 2011/0216013 A1
(43) Pub. Date: Sep. 8, 2011

(54) Touch-sensitive input device, touch screen device, mobile device and method for operating a touch-sensitive input device

(75) Inventor: Georg SIOTIS, Lund (SE)

(73) Assignee: SONY ERICSSON MOBILE COMMUNICATIONS AB, Lund (SE)

(21) Appl. No.: 12/718,126

(22) Filed: Mar. 5, 2010

(51) Int. Cl. G08B 6/00; G06F 3/041

(52) U.S. Cl. 345/173; 340/407.2

(57) ABSTRACT

The invention relates to a touch-sensitive input device, a touch screen device, a mobile device and a method for operating a touch-sensitive input device to provide for a more realistic haptic feedback to a user in response to an input. The touch-sensitive input device comprises a first layer, a second layer facing said first layer, said first and second layers defining a cavity accommodating a substance capable of flowing, and an actuator device arranged to vary the pressure of said substance in said cavity so as to provide haptic feedback to a user touching a surface of said touch-sensitive input device.

### FIELD OF THE INVENTION

The invention relates to a touch-sensitive input device, a touch screen device, a mobile device and a method for operating a touch-sensitive input device. In particular, the touch-sensitive input device may serve as a user interface allowing interactions between a user and a mobile device.

### BACKGROUND

Various kinds of sensors serving as user interfaces in different devices, such as mobile communication devices, are known in the art for sensing an input action of a user. When using a touch sensor, such as a touch screen of a mobile device, the input is performed by touching the sensor surface with a finger or a stylus. Hence, touch sensors may provide a user interface or man-machine interface to control various functions of the device having the touch sensor incorporated therein.

Known touch sensors, which are often combined with liquid crystal displays (LCDs) to form a touch screen, work by reacting to a change in capacitance, resistance or inductance effected by the touch of a finger or a stylus of the user on top of the sensor. However, since a touch screen is usually a flat surface and functional buttons or keys are only provided as a virtual image on the LCD below the touch sensor, the user does not feel individual buttons or keys anymore, as in conventional keyboards or keypads. More importantly, the user does not get any haptic feedback anymore from the virtual button he or she has pressed. Often, the user does not even know whether the virtual button has been pressed at all and whether the function assigned to it has been triggered, since there is no haptic or tangible response to the finger and there may be a delay in processing the input command, i.e. the function associated with the virtual button, due to processor speed or similar.

In state of the art devices, feedback is provided, for example, by changing the image of the virtual button on the screen, e.g. increasing the size of the virtual button. Another form of feedback may be to let the device vibrate, which could be done by a vibration apparatus commonly used in mobile phones.

However, all these solutions cannot replace the feeling that a user gets from pressing down a real key of a keypad, namely the feeling at a finger of pressing down a key and the key coming back up after being pressed down, since changing the size of a virtual button constitutes optical feedback to the eyes of the user and vibration may cause feedback to the hand of a user holding a mobile device.

Therefore, it is desirable to provide an improved touch-sensitive input device, touch screen device, mobile device and method that provide for more realistic haptic feedback to a user in response to an input.

### DISCLOSURE OF INVENTION

A novel touch-sensitive input device, touch screen device, mobile device and method for operating a touch-sensitive input device are presented in the independent claims. Advantageous embodiments are defined in the dependent claims.

An embodiment of the invention provides a touch-sensitive input device comprising a first layer and a second layer facing the first layer. The first and second layers define a cavity accommodating a substance capable of flowing. The touch-sensitive input device further comprises an actuator device arranged to vary the pressure of the substance in the cavity so as to provide haptic feedback to a user touching a surface of the touch-sensitive input device. Accordingly, by changing the pressure in the cavity, the cavity can be deformed, e.g. the first layer bulges, so that the user can feel the deformation on his finger touching the touch-sensitive input device. Therefore, haptic feedback is provided to a user directly to the finger or stylus performing the input operation.

In one embodiment, the touch-sensitive input device further comprises a channel for carrying the substance. In particular, the actuator device and the cavity are adapted and coupled by the channel so that activation of the actuator device pushes substance through the channel into the cavity so as to deform the cavity. Accordingly, there is a high flexibility in placing the actuator device and the actuator device does not have to be placed adjacent to or in proximity of the cavity and triggering the actuator device may lead to deformation of the cavity at a remote position from the actuator device itself.

In one embodiment, the actuator device comprises at least one piezoelectric element and/or a reservoir for storing the substance, which reservoir comprises elastic walls, for example. Accordingly, a compact actuator device can be provided, which can be activated by an electric pulse or current so as to press parts of the substance in the cavity.

In one embodiment, the actuator device is arranged to vary the pressure in the cavity in response to sensing a finger or input instrument, such as a stylus, above the first layer. Accordingly, a finger or other input instrument of a user performing an input operation can be provided with feedback so as to provide a realistic response to pressing a button.

For example, the first layer comprises a touch sensor to sense a position touched by the finger or input instrument on a touch area defined by the touch sensor. In another example, the actuator device is adapted to sense a pressure of the substance in the cavity effected by a force acting on the first layer, wherein the force is applied by a finger or input instrument, for example. Accordingly, various kinds of input operations may lead to provision of haptic feedback in response to the input operation so that a realistic feeling of pressing a physical key or button can be provided.

In one embodiment, the touch-sensitive input device comprises a determination section operable to determine a signal level based on the sensed pressure in the cavity. Accordingly, by determining the signal level, a force or pressure acting on a layer of the cavity is obtained. For example, it is then possible to increase the pressure by the actuator device in response to the determined signal level based on the magnitude of the sensed pressure.

According to another embodiment, a touch screen device comprises the above-described touch-sensitive input device as well as a display device. Preferably, at least one of the first and second layers is made at least partly of a transparent material and the display device is provided on a side of the second layer other than the side facing the substance. Accordingly, a touch screen device having a display device can be provided, allowing to view different virtual keys and in response to selecting a function of a virtual key haptic feedback may be provided.

According to another embodiment, a mobile device is provided comprising one of the described touch-sensitive input devices or the touch screen device. Accordingly, a mobile device may be provided with a novel type of a feedback providing input device so that haptic feedback can be provided to a user operating the mobile device.

Another embodiment of the invention provides a method for operating a touch-sensitive input device, such as one of the above-described touch-sensitive input devices, having first and second layers forming a cavity accommodating a substance capable of flowing. The method comprises the steps of sensing a finger or input instrument above the first layer and varying the pressure of the substance in the cavity so as to provide haptic feedback to a user touching a surface of the touch-sensitive input device. Accordingly, haptic feedback can be provided to a user when performing an input operation so that a more or less realistic feeling of touching a physical key or button can be achieved.

### BRIEF DESCRIPTION OF THE DRAWINGS

Embodiments of the invention will be described with respect to the following appended figures.

FIG. 1a illustrates a touch-sensitive input device and elements thereof according to an embodiment of the invention.

FIG. 1b illustrates a touch-sensitive input device and elements thereof when the pressure in the cavity of the touch-sensitive input device is increased.

FIG. 2a illustrates a touch-sensitive input device in operation according to another embodiment.

FIG. 2b illustrates the touch-sensitive input device of a FIG. 2a in another operation state.

FIG. 3 illustrates a flow diagram of a method for operating a touch-sensitive input device according to an embodiment of the invention.

FIG. 4 illustrates a specific example of a touch-sensitive input device according to another embodiment of the invention, which may particularly be useful when integrated in a mobile device.

FIG. 5 illustrates a touch screen device comprising the touch-sensitive input device according to another embodiment of the invention.

### DESCRIPTION OF THE EMBODIMENTS

The further embodiments of the invention are described with reference to the figures and should serve to provide the skilled person with a better understanding of the invention. It is noted that the following description contains examples only and should not be construed as limiting the invention.

In the following, similar or same reference signs indicate similar or same elements.

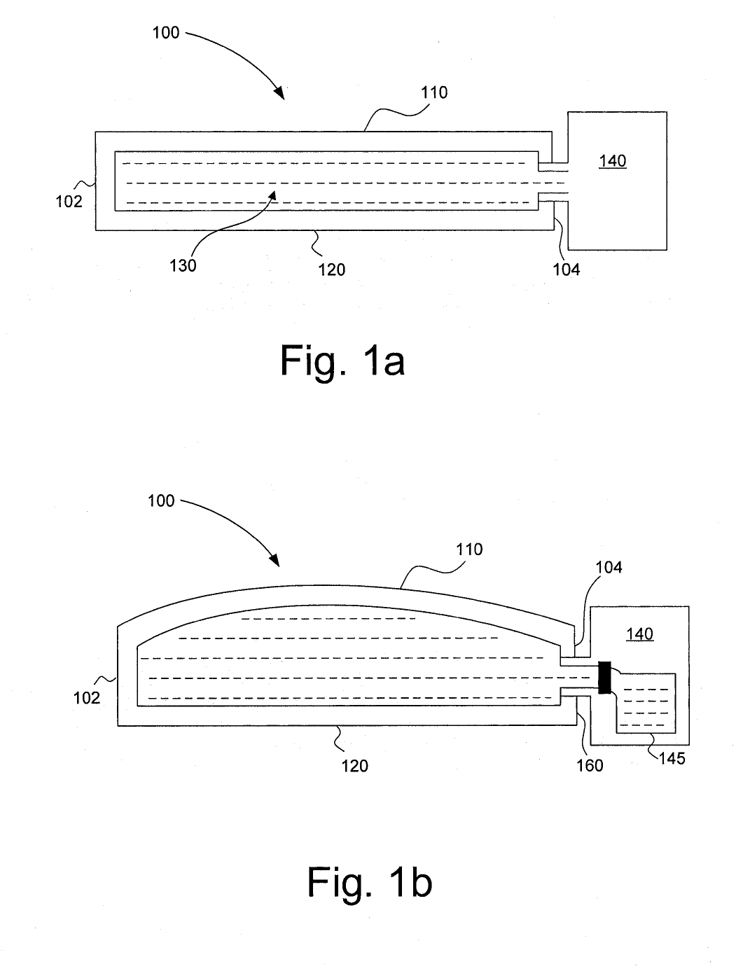

FIG. 1a and FIG. 1b illustrate elements of a touch-sensitive input device according to an embodiment of the invention. FIG. 1a illustrates a touch-sensitive input device 100 comprising a first layer 110, a second layer 120 and an actuator device 140. As shown in FIG. 1a, the second layer 120 is arranged at one side, here at the bottom side, of the first layer 110, and faces the first layer. The first layer 110 and the second layer 120 define a cavity accommodating a substance 130. The cavity may have a thickness of 0.1 to 1 mm, in particular when used in a mobile device, so that side walls may not be necessary since the layer may be attached to each other at their side ends directly forming a kind of bag.

In more detail, the cavity shown in FIG. 1a and FIG. 1b is constituted, in the specific example shown in the figures, by the two layers 110, 120 and side walls 102 and 104, wherein an opening, here in side wall 104, is provided in the cavity to allow a flow of the substance to and from the actuator device 140. The cavity contains the substance indicated with dashes. The substance is a substance capable of flowing in the cavity and from/to the actuator device 140. For example, the substance may be any kind of fluid, e.g. a liquid, gas or gel, wherein the latter will be considered as suitable substance for illustrative purposes in the following.

The actuator device 140 is arranged to vary the pressure of the substance, e.g. the gel, in the cavity so as to provide haptic feedback to a user touching a surface of the touch-sensitive input device 100. For example, the actuator device 140 comprises one or two piezoresistive elements so that an increase in pressure can be produced by activation of the piezoresistive elements, e.g. by providing a current pulse thereto.

In detail, the cavity is made deformable or flexible so that the shape of the cavity may change in response to a variation in the pressure in the cavity.

For example, as shown in FIG. 1b, the first layer, which may constitute or be placed below a lower surface of a touch sensor, is made deformable so as to bulge, as shown in FIG. 1b, when the pressure in the cavity is increased. This effect may then be detected by a user touching the surface of the first layer or a different layer on top of the first layer with a finger or other input instrument, such as a stylus.

It should be clear that FIG. 1b only shows one example of a deformation of the cavity, and it is clear that instead of a deformation of the first layer 110, the shape of the cavity may be changed differently. For example the height of the side walls 102 and 104 may increase which may also be detected by a user touching the touch-sensitive input device 100.

Further, it is preferable that the deformable part or parts, such as the first layer 110, is also flexible enough, to go back to the previous shape before an increase in pressure occurred so that changes in shape/volume of the cavity may be repeated at a later stage. In other words, the actuator device 140 and the cavity should be adapted so that an activation of the actuator device pushes gel in the cavity changing its shape. Similarly, the actuator device may be adapted to retract gel from the cavity so as to decrease the pressure in the cavity and so that the shape of the cavity goes back to its original shape.

To enable the actuator device 140 to change the amount of gel in the cavity, i.e. pushing in or retracting gel in/from the cavity, the actuator device 140 comprises a reservoir 145, in which the substance, such as gel, liquid or other fluid may be stored. The reservoir 145 is shown in FIG. 1b and may be provided with elastic walls which are able to transmit pressure from the actuator device 140 to the cavity. For example, the actuator device 140 may comprise one or two piezoelectric actuators acting on the reservoir walls so that the pressure built up in the reservoir 145 is transmitted through the previously described opening to the cavity. In the example of FIG. 1b the opening in the cavity is illustrated as a channel 160 connecting the cavity and the reservoir 145. The channel 160 carries the gel and couples the actuator device 140 and the cavity so that activation of the actuator device 140 pushes the gel through the channel 160 into the cavity to increase the pressure in the cavity and deform the cavity.

In FIGS. 1a and 1b the actuator device 140 is placed at the side wall 104 outside the cavity. However, it is also feasible that the actuator device is placed inside the cavity thereby omitting the need for an opening and/or a channel. However using a channel, such as the channel 160, e.g. a pipe or tube, allows to be flexible in the design and arrangement of the elements of the touch-sensitive input device 100.

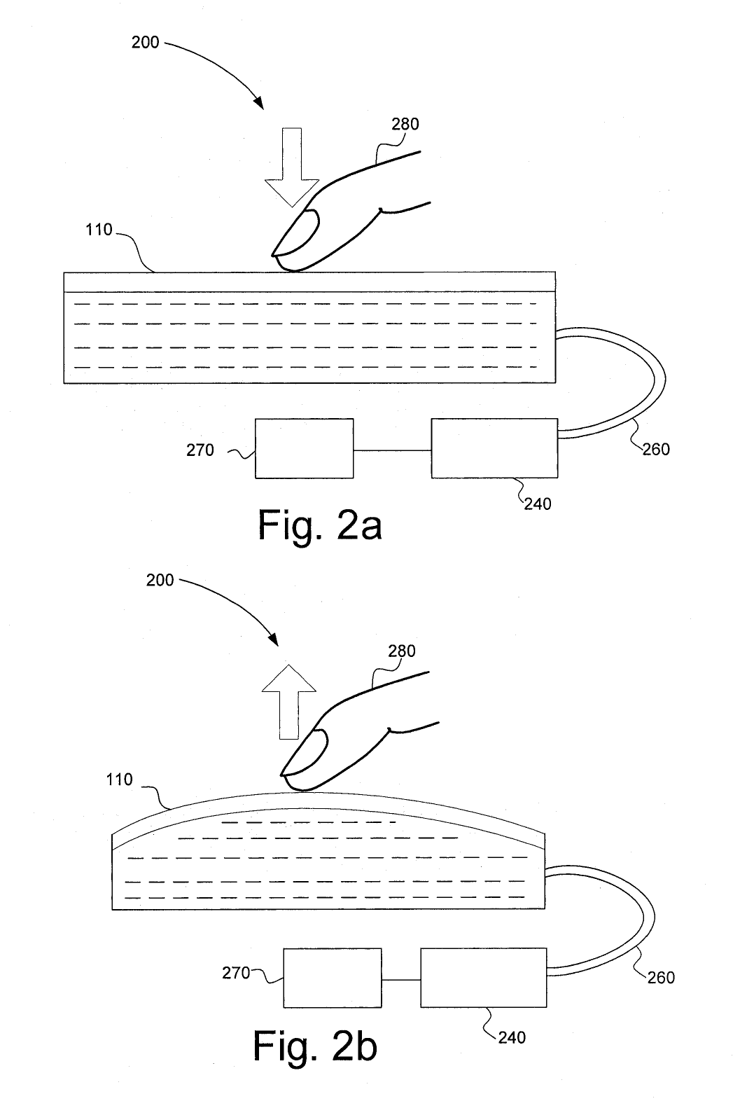

In the following, with respect to FIGS. 2a and 2b, the operation of the touch-sensitive input device will be described in a specific example. In this example, an actuator device 240, which basically corresponds to the actuator device 140, is connected to the cavity by a channel 260. The cavity has the same structure as described in FIGS. 1a and 1b. Further, the actuator device 240 is connected to a determination section which will be described later. In this example, the actuator device 240 is arranged to vary the pressure in the cavity in response to sensing a finger or other input instrument above the first layer 110.

There are several different ways of detecting the presence of a finger 280 on top of the touch-sensitive input device 200. For example, the first layer 110 may comprise a touch sensor to sense a position touched by the finger or other input instrument on a touch area defined by the touch sensor. The touch sensor may be any x-y touch sensor as known in the art, e.g. capacitive, resistive or inductive touch sensor, to determine a position or the coordinates of the touched area. It is clear that for touching a touch-sensitive input device, any finger including the thumb or other suitable input instrument, such as a stylus, can be used.

Another way of sensing a finger or other input instrument on top of a touch-sensitive input device 200, such as layer 110, is described in more detail in the following.

Since the actuator device 240 is operable to vary the pressure, e.g. increase the pressure by pushing out gel in the cavity using piezoelectric elements, for example, the actuator device 240 may also be used to sense a pressure in the gel. In particular, a pressure change in the gel caused by touching and slightly pressing down the first layer 110, may be sensed, when the volume of the cavity changes due to a force or pressure from the outside. For example, the external force may be applied from the outside by a finger of the user pressing against the first layer, which is indicated by the arrow in FIG. 2a. Depending on the area, on which the force is applied, a pressure may be determined so that pressure and force are proportional and will be used interchangeably in the following.

As described above, the actuator device 240 and the cavity are adapted and coupled, in this example by the channel 260, so that a force applied to the first layer 110 is communicable through the gel to the actuator device 240 sensing an increase in pressure once a force is applied on the cavity. It is clear that in the case of totally stiff walls and layers of the cavity, the pressure in the cavity does not change once a force is applied to the cavity and thus the force cannot be detected.

Therefore, it is preferable that the first layer 110 is made of a somewhat flexible, elastic or resilient material so that the shape may change as mentioned above, and the force acting on the first layer 110 may also act on the gel in the cavity.

Similarly, the same effect may be achieved with a very stiff and rigid first layer 110 when other parts of the cavity are flexible, elastic or resilient, such as for example the side walls 102 and/or 104, as described above. That is, the cavity which forms a chamber for retaining the substance, i.e. the gel, is adapted to change its volume and shape once a force is applied from the outside. In other words, a closed compartment to store gel is provided and a change in the shape and thus volume of the cavity leads to an increase of the pressure so that the finger 280 can be sensed.

The extent of the pressure increase due to a finger touching the first layer 110 may be determined by the determination section 270, which may be also incorporated in a controller. Using this information even a change in the ambient pressure may be detected, e.g. due to weather changes or changes in altitude.

In detail, the determination section 270 determines a signal level based on the sensed pressure of the actuator device 240. For example, the actuator device 240 may comprise one or more piezoelectric elements that output a voltage signal, wherein the height of the signal corresponds to the pressure so that an increase in pressure relates to an increase in voltage and a specific value of the force expressed in Newton or value of the force expressed in a percentage change compared to a reference value or a pressure value may be provided. Therefore, the actuator device 240 may also be operated as a pressure sensor.

For example, a threshold of a voltage value may be defined, which lies in between a voltage output at ambient pressure and a voltage output when a force is applied. Therefore, once the determination section 270 detects a voltage value larger than the threshold value, it is determined that a user presses a finger, a hand or a stylus on the touch-sensitive input device performing an input operation.

The response of the touch-sensitive input device 200 to sensing a finger above the first layer 110 is shown in FIG. 2b. In FIG. 2b, the actuator device 240 increases the pressure in the cavity by pushing more gel in the cavity so that the first layer 110 bulges and a force, shown by the arrow, to lift up the finger 290 is provided. Accordingly, the user obtains haptic feedback in response to sensing his/her finger. In other words, the actuator device 240 is adapted to sense a pressure, or pressure change depending on a force applied to the first layer 110, in the cavity effected by the force acting on the first layer.

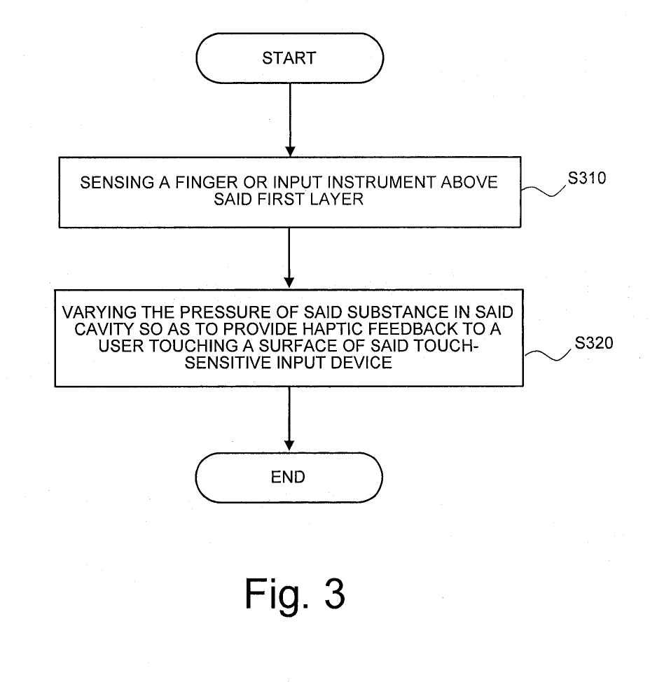

In the following, a method for operating a touch-sensitive input device, such as the touch-sensitive input device 100, 200 or 400 (discussed below), will be described with respect to FIG. 3.

The touch-sensitive input device comprises first and second layers forming a cavity accommodating a substance capable of flowing, as discussed above. In a first step S310 a finger or other input instrument is sensed above the first layer. This can be performed with one of the above-described methods, i.e. a touch sensor detecting the presence of a finger in an x-y plane or by detecting a pressure applied by the finger on the cavity.

In response thereto, in step S320, the pressure of the substance in the cavity is varied so as to provide haptic feedback to a user touching a surface of the touch-sensitive input device. Haptic feedback should be understood in all examples as the effect of a change in the shape of the cavity due to a pressure increase that can be sensed by a user and may also be called tactile feedback. The extent of the haptic feedback felt by the user depends on the degree of change in the shape of the cavity and where this change is located.

Varying the pressure in the cavity to provide haptic feedback may also include decreasing the pressure so that the shape of the cavity changes. In this case, the user would feel a dent in the first layer 110. However, since the haptic feedback should mimic the movement of a physical key of a keypad when pressing it down and feeling it coming up after being pressed, it is preferable that the first layer 110 bulges in response to sensing a finger.

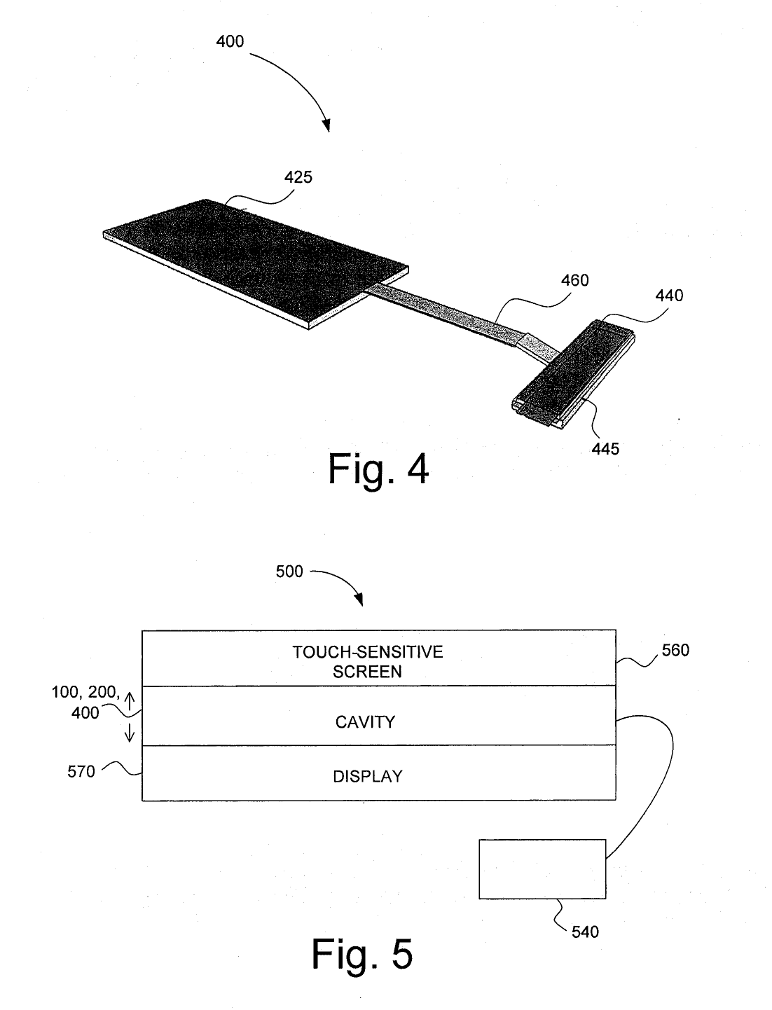

In FIG. 4 a specific example of a touch-sensitive input device is shown. The touch-sensitive input device 400 is particularly suitable to be used for a mobile device, such as a mobile phone. For example, it may be placed between a touch screen and an LCD device. A cavity 425 filled with sensory gel which may have a rather thick consistence is connected via a thin pipe 460 constituting a channel carrying gel to an actuator device 440 having a reservoir 445. The gel is floating between the upper and lower layer of the cavity which may be part of the lower surface of a touch sensor and upper surface of an LCD device, respectively.

As described above, the pressure exerted by a finger of a user may be transmitted to the actuator device 440 also acting as a pressure sensor. Then, the applied pressure can be converted to an analogue voltage and set to A/D converter to calculate the applied force.

Similar to sensing a force applied to the cavity 425, feedback can be provided by means of increasing the amount of gel in the cavity. Therefore, as previously described with respect to FIG. 1b, a reservoir 445 with gel can be kept close to the cavity and piezoelectric elements may be placed around the reservoir to squeeze out gel in the channel and subsequently in the cavity so that the user gets direct feedback from the cavity and not from other parts of a mobile device using this touch-sensitive input device. As described above, pressure may be communicated by the gel from the cavity to the actuator device 440 and vice versa passing through the thin pipe 460 that allows placing the actuator device 440 at a convenient location.

Next, a touch screen device is explained with respect to FIG. 5.

FIG. 5 illustrates a touch screen device 500 comprising a display device 570, a touch-sensitive screen 560 constituting a touch sensor and the touch-sensitive input device 100, 200 or 400, as described above.

The touch-sensitive screen 560 basically provides for detecting an x-y-position of a finger touching the touch screen device. Therefore, if the x-y-position of a finger is not important or can be measured differently, this element 560 may also be omitted.

The display device 570 may be an LCD device or other suitable display, e.g. an organic light-emitting display known as OLED. As described above, the cavity for accommodating the gel may be formed by the touch-sensitive screen 560 and display device 570. In other words, the touch-sensitive screen 560 and the display device 570 may constitute the first layer and the second layer, respectively. Therefore, it should be clear that the first and second layers may be layers of other elements, such as elements 560 and 570 or individual distinct layers not being part of other elements, such as a touch-sensitive screen or display device. Further, when using a display device at the bottom of the structure 500, at least parts of the first and second layers should be made of a transparent material so that images displayed on the display device provided on a side of the second layer other than the side facing the gel, can be seen from the top of the touch screen device 500.

In FIG. 5, an actuator device 540 is also shown. This actuator device is basically the same as previously described actuator devices 140, 240 and 440 and a detailed discussion will be omitted and it is referred to the previous sections.

The touch screen device 500 may be incorporated in a mobile device, such as a mobile phone. For example, when a user of a mobile phone using the touch screen device 500 wants to make a call, the display device may be adapted to show an image of a keypad with numbers, e.g. digits from zero to nine which can be pressed to dial a telephone number. When the user wants to dial “8”, the user presses the “8”-virtual key (an icon on the display) and the touch-sensitive screen 560 registers the touched position which corresponds to the “8”-key. In response to the sensed position, the actuator device 540 pumps gel into the cavity of the touch-sensitive input device so as to slightly lift up the touch-sensitive screen 560 which can be felt by the user having his finger on the “8”-key.

Therefore, the user is provided with haptic feedback confirming that he pressed a key and that the input is registered. Consequently, the touch screen device 500 may provide a feeling similar to a physical keyboard providing a better operation experience and reducing the reluctance to change to mobile devices with touch screen devices.

It is noted that the structure, and in particular the sequence of layers and elements shown in FIG. 5 is not limited to the above-described examples. As described above, gel may be replaced by any kind of fluid, such as a liquid or gas and the touch-sensitive input device does not have to be sandwiched between the touch-sensitive screen 560 and the display device 570 but may be placed on top of the touch-sensitive screen that is placed on top of the display device.

Furthermore, the touch-sensitive screen 560 may be placed on the display device and both of these elements may then be placed on the touch-sensitive input device, i.e. the cavity thereof. Such an arrangement is also possible, since the effect of a cavity changing its shape can be quite small to be still detectable by the user so that lifting up the touch-sensitive screen and display device by roughly 1 mm may still be detectable by the user.

According to another example, the cavity of the touch-sensitive input device may be the cavity of an LCD device and the substance may be a bi-refringent liquid.

Furthermore, the above-described touch-sensitive input devices may be controlled by a controller that may be adapted to carry out the steps of the above-described method. The invention also relates to computer programs for carrying out the above-described method steps and to a computer readable medium storing the computer programs for carrying out the method according to the invention.

It will be appreciated that various modifications and variations can be made in the described elements, touch-sensitive input devices, touch screen devices, mobile devices and methods as well as in the construction of this invention without departing from the scope or spirit of the invention. The invention has been described in relation to particular embodiments which are intended in all aspects to be illustrative rather than restrictive. Those skilled in the art will appreciate that many different combinations of hardware, software and firmware are suitable for practising the invention.

Moreover, other implementations of the inventions will be apparent to the skilled person from consideration of the specification and practice of the invention disclosed herein. It is intended that the specification and the examples are considered as exemplary only. To this end, it is to be understood that inventive aspects lie in less than all features of a single foregoing disclosed implementation or configuration. Thus, the true scope and spirit of the invention is indicated by the following claims.

1. Touch-sensitive input device, comprising
a first layer;
a second layer facing said first layer, said first and second layers defining a cavity accommodating a substance capable of flowing; and
an actuator device arranged to vary the pressure of said substance in said cavity so as to provide haptic feedback to a user touching a surface of said touch-sensitive input device.

2. Touch-sensitive input device of claim 1, further comprising a channel for carrying said substance, wherein
said actuator device and said cavity are adapted and coupled by said channel so that activation of said actuator device pushes substance through said channel into said cavity so as to deform said cavity.

3. Touch-sensitive input device of claim 1, wherein said actuator device comprises at least one piezoelectric element.

4. Touch-sensitive input device of claim 1, wherein said actuator device comprises a reservoir for storing said substance.

5. Touch-sensitive input device of claim 4, wherein said reservoir comprises elastic walls.

6. Touch-sensitive input device of claim 1, wherein said actuator device is arranged to vary said pressure in said cavity in response to sensing a finger or input instrument above said first layer.

7. Touch-sensitive input device of claim 6, wherein said first layer comprises a touch sensor to sense a position touched by said finger or input instrument on a touch area defined by said touch sensor.

8. Touch-sensitive input device of claim 6, wherein said actuator device is adapted to sense a pressure of said substance in said cavity effected by a force acting on said first layer.

9. Touch-sensitive input device of claim 8, further comprising
a determination section for determining a signal level based on the sensed pressure.

10. Touch screen device comprising said touch-sensitive input device of claim 1 and a display device.

11. The touch screen device of claim 10, wherein at least one of said first and said second layers is made at least partly of a transparent material and said display device is provided on a side of said second layer other than the side facing said substance.

12. Mobile device comprising said touch-sensitive input device of claim 1.

13. Mobile device comprising said touch screen device of claim 10.

14. Method for operating a touch-sensitive input device having first and second layers forming a cavity accommodating a substance capable of flowing, the method comprising the steps
sensing a finger or input instrument above said first layer; and
varying the pressure of said substance in said cavity so as to provide haptic feedback to a user touching a surface of said touch-sensitive input device.
